(19) United States
(12) Patent Application Publication
(10) Pub. No.: US 2010/0247196 A1
(43) Pub. Date: Sep. 30, 2010

(54) RECORDING MEDIUM TRANSPORT MECHANISM, FIXING DEVICE AND IMAGE FORMING APPARATUS

(76) Inventors: Yukihiro Ichiki, Saitama (JP); Yasuki Tanaka, Saitama (JP); Yoshiyasu Tanioka, Saitama (JP)

Correspondence Address: MORGAN LEWIS & BOCKIUS LLP, 1111 PENNSYLVANIA AVENUE NW, WASHINGTON, DC, 20004, US

(21) Appl. No.: 12/630,152

(22) Filed: Dec. 3, 2009

(30) Foreign Application Priority Data
Mar. 27, 2009 (JP) 2009-080564

(51) Int. Cl. G03G 15/00

(52) U.S. Cl. 399/381

(57) ABSTRACT

A recording medium transport mechanism including: a transporting device provided in a transport-path of medium, that transports the recording medium by a drive-roller and a facing-roller disposed to face the drive-roller; an urging member that urges the facing-roller toward the drive-roller; and a restricting portion that allows movement of the facing-roller away from the drive-roller against urging force of the urging member when the recording medium having thickness smaller than a predetermined thickness is transported in a region the drive-roller and the facing-roller facing each other, and restricts an allowable amount of movement of the facing-roller away from the drive-roller when the recording medium having thickness not smaller than the predetermined thickness is transported in the region compared to an allowable amount of movement of the facing-roller away from the drive-roller when the recording medium having thickness smaller than the predetermined thickness is transported is provided.

### CROSS-REFERENCE TO RELATED APPLICATION

This application is based on and claims priority under 35 USC 119 from Japanese Patent Application No. 2009-080564 filed Mar. 27, 2009.

### BACKGROUND

### Technical Field

The present invention relates to a recoding medium transport mechanism, a fixing device and an image forming apparatus.

### SUMMARY

According an aspect of the invention, a recording medium transport mechanism includes: a transporting device that is provided in a transport path of a recording medium, and that transports the recording medium by a drive roller and a facing roller that is disposed to face the drive roller; an urging member that urges the facing roller toward the drive roller; and a restricting portion that allows movement of the facing roller away from the drive roller against urging force of the urging member when the recording medium having thickness smaller than a predetermined thickness is transported in a region in which the drive roller and the facing roller face each other, and restricts an allowable amount of movement of the facing roller away from the drive roller when the recording medium having thickness equal to or larger than the predetermined thickness is transported in the region in which the drive roller and the facing roller face each other compared to an allowable amount of movement of the facing roller away from the drive roller when the recording medium having thickness smaller than the predetermined thickness is transported.

### BRIEF DESCRIPTION OF THE DRAWINGS

Exemplary embodiments of the invention will be described in detail with reference to the following figures, wherein:

FIG. 1 is a schematic side view of an image forming apparatus according to an exemplary embodiment of the present invention.

FIG. 2 is a schematic perspective view showing facing rollers according to a first exemplary embodiment of the present invention.

FIG. 3 is an enlarged perspective view that schematically shows facing rollers according to the first exemplary embodiment.

FIG. 4 is an enlarged plan view that schematically shows facing rollers according to the first exemplary embodiment.

FIG. 5 is an enlarged side view that schematically shows facing rollers according to the first exemplary embodiment when plain paper is transported.

FIG. 6 is an enlarged side view that schematically shows facing rollers according to the first exemplary embodiment when a cardboard sheet is transported.

FIG. 7A is an enlarged front elevational view that schematically shows the configuration of a recording medium transported by the facing rollers according to the first exemplary embodiment.

FIG. 7B is an enlarged front elevational view that schematically shows the configuration of a recording medium transported by facing rollers according to a comparative example.

FIG. 8 is an enlarged perspective view that schematically shows the facing rollers according to the first exemplary embodiment.

FIG. 9 is an enlarged side view that schematically shows the facing rollers according to the first exemplary embodiment of the present invention when plain paper is transported.

FIG. 10 is an enlarged side view that schematically shows the facing rollers according to the first exemplary embodiment of the present invention when a cardboard sheet is transported.

FIG. 11 is an enlarged plan view that schematically shows facing rollers according to a modified example of the first exemplary embodiment.

FIG. 12 is an enlarged side view that schematically shows the facing rollers according to the modified example of the first exemplary embodiment when plain paper is transported.

FIG. 13 is a schematic plan view showing the facing rollers according to the first exemplary embodiment, which rollers are provided so as to reduce curling occurring at the central portion of the recording medium in the widthwise direction.

FIG. 14 is a schematic plan view showing the facing rollers according to the first exemplary embodiment, which rollers are provided so as to reduce curling occurring at both end portions of the recording medium in the widthwise direction.

FIG. 15 is an enlarged perspective view that schematically shows facing rollers according to a second exemplary embodiment of the present invention.

FIG. 16A is a schematic side view showing facing rollers according to a third exemplary embodiment of the present invention when plain paper is transported.

FIG. 16B is a schematic side view showing facing rollers according to the third exemplary embodiment of the present invention when a cardboard sheet is transported.

### DETAILED DESCRIPTION

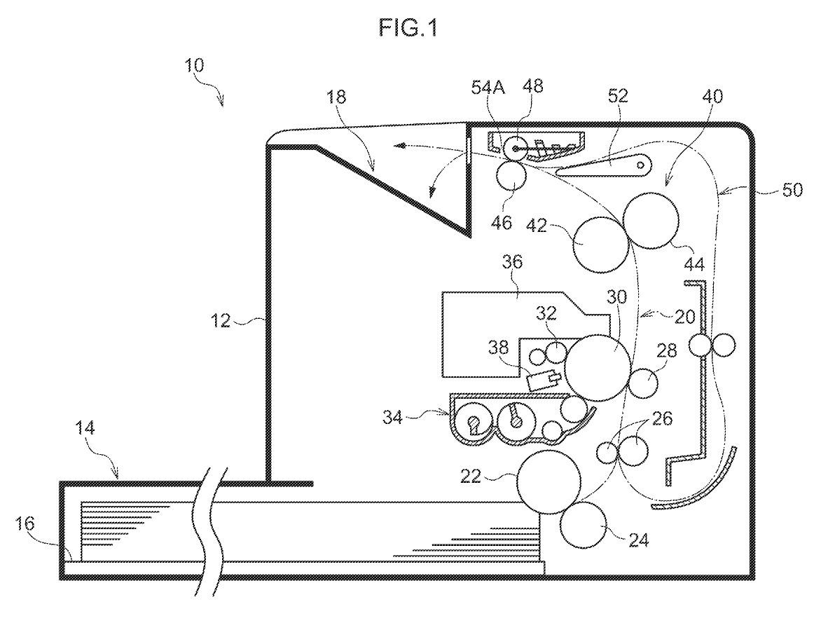

Exemplary embodiments of the present invention are hereinafter described on the basis of examples illustrated in the figures. As shown in FIG. 1, an image forming apparatus 10 includes an image forming apparatus main body 12, and a paper feed unit (an example of an accommodating unit) 14 in which a recording sheet (an example of recording medium) P is accommodated is disposed at a lower portion of the image forming apparatus main body 12. Then, a paper discharge unit (an example of a discharge unit) 18 from which the recording sheet P with a toner image (an image) being fixed thereon is discharged, is formed at an upper portion of the image forming apparatus main body 12.

The paper feed unit 14 includes a sheet cassette 16 in which a large number of recording sheets P are laminated and accommodated, and a feed roller 22 is disposed in an upper portion of the sheet cassette 16 at its one end side (in FIG. 1, at the rightward side of the sheet cassette). A retard roller 24 is provided so as to face the feed roller 22.

Accordingly, the recording paper P located at the uppermost position of the sheet cassette 16 is taken out by the feed roller 22, and handled by cooperation of the feed roller 22 and the retard roller 24, and further delivered to a transport path 20. The recording sheet P delivered to the transport path 20 stops temporarily by a registration roller 26 disposed further at the upstream side in the sheet transporting direction than a photoreceptor 30, and is sequentially transported toward the photoreceptor 30.

The photoreceptor 30 configuring a transfer member is supported in a rotatable manner. Provided around the photoreceptor 30 are a charging roller 32 that charges the photoreceptor 30 uniformly, a development device 34 that develops a latent image formed on the photoreceptor 30 with a toner (developer), and a cleaning device 36 that removes the toner remaining on the surface of the photoreceptor 30 after transfer of a toner image.

A light writing device 38 is disposed between the charging roller 32 and the development device 34. Due to the surface of the photoreceptor 30 being irradiated with light, a latent image comes to be formed on the surface of the photoreceptor 30. A backup roller 28 configuring a transfer member is disposed so as to face the photoreceptor 30 with the transport path 20 interposed therebetween.

Further, a fixing device 40 is provided further at the downstream side in the sheet transporting direction than the photoreceptor 30 and the backup roller 28. In the fixing device 40, a heat roller (an example of a fixing member) 42 and a press roller (an example of the fixing member) 44 are disposed so as to face each other, and the recording sheet P on which an unfixed toner image is transferred is nipped and transported by the heat roller 42 and the press roller 44. In this manner, the unfixed toner image is fixed on the recording sheet P.

A discharge roller (an example of a drive roller and also is an example of a transporting member) 46 and a pinch roller set (an example of a facing roller and is an example of the transporting member) 48 are disposed so as to face each other at the downstream side of the heat roller 42 and the press roller 44 of the fixing device 40 in the sheet transporting direction. Accordingly, the recording sheet P on which a toner image is fixed is discharged onto the paper discharge unit 18 by being nipped and transported by the discharge roller 46 and the pinch roller set 48 while curling of the recording sheet toward the side of the heat roller 42 (toward the surface to be printed) is being straightened (reduced).

In the fixing device 40, the heat roller 42 and the discharge roller 46 are disposed at the lower side, and the press roller 44 and the pinch roller set 48 are disposed at the upper side. Further, provided in the transport path 20 between “the heat roller 42 and the press roller 44” and “the discharge roller 46 and the pinch roller set 48” is a reversal gate 52 that guides the recording paper P to the reversal unit 50 when both surfaces of the recording sheet P are printed.

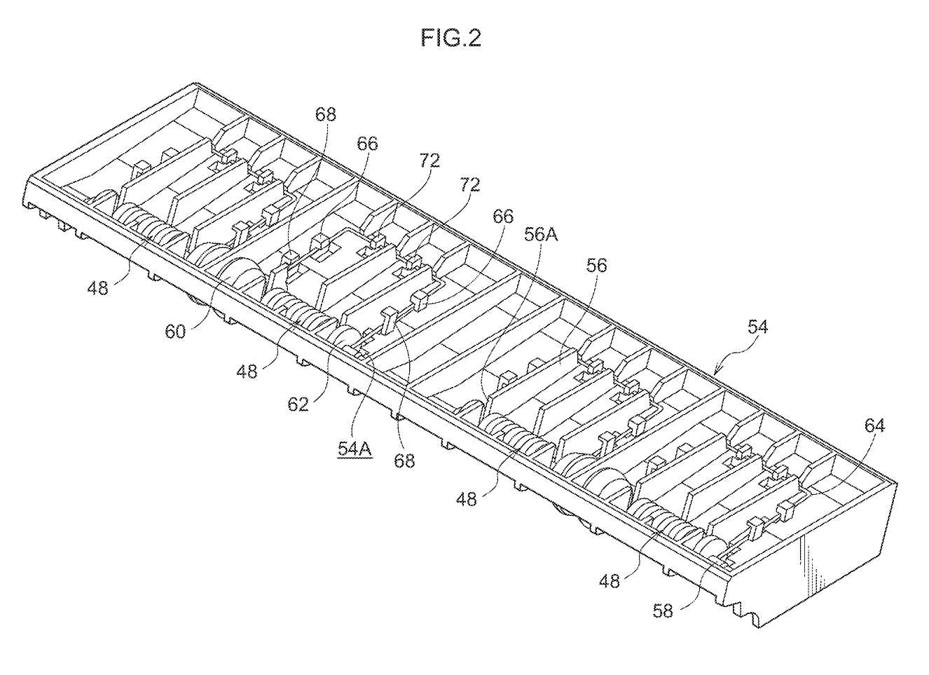

In the image forming apparatus 10 having the aforementioned structure, the structure of the pinch roller set 48 is described hereinafter in detail. First, a first exemplary embodiment is described. As shown in FIG. 2 through FIG. 4, the pinch roller sets 48 are provided in a cover body 54 in roller freely rotatable manner at the downstream side in the sheet transporting direction, the cover body 54 configuring a top portion of the fixing device 40.

In other words, plural (for example, four) opening portions 54A are formed and opened in the cover body 54 at the downstream side in the sheet transporting direction and at predetermined intervals therebetween along the sheet widthwise direction (the axial direction of the discharge rollers 46). The opening portions 54A are formed to allow plural (for example, four) pinch roller sets 48 described later to be exposed toward the side of the discharge rollers 46. Plural reinforcing ribs 56 are provided on the upper face of the cover body 54 so as to be arranged in parallel with one another at predetermined intervals therebetween in the sheet widthwise direction.

A notch portion 56A having a substantially U-shaped configuration when seen from the side is each formed in some of the reinforcing ribs 56 at the downstream side in the sheet transporting direction, so as to temporarily support a rotating shaft 58 of each of pinch roller sets 48 before the pinch roller set 48 is made to come in contact (by pressure) with the discharge roller 46. A concave portion 54B having a rectangular configuration when seen from the top is formed in a portion of a peripheral edge (at the sheet transporting direction side) of each opening portion 54A of the cover body 54, so as to accept (accommodate) the end portion of the rotating shaft 58.

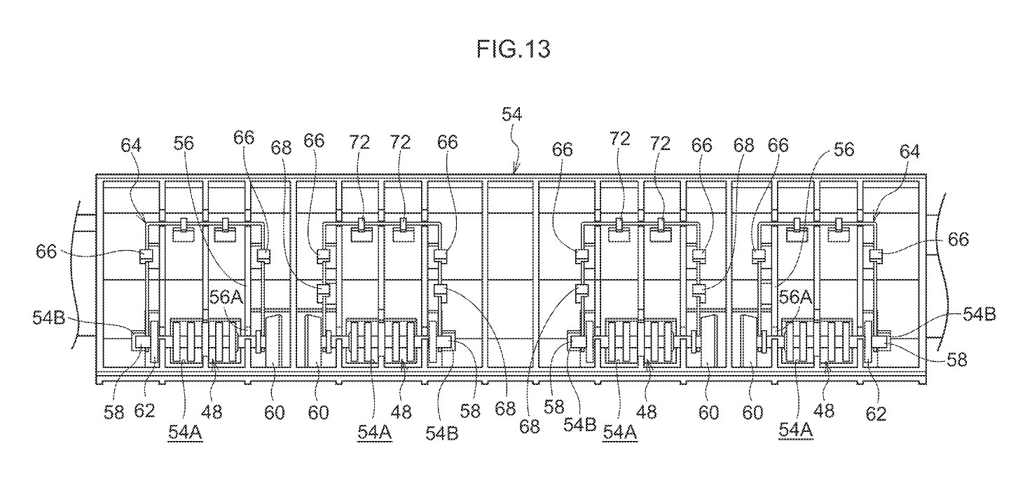

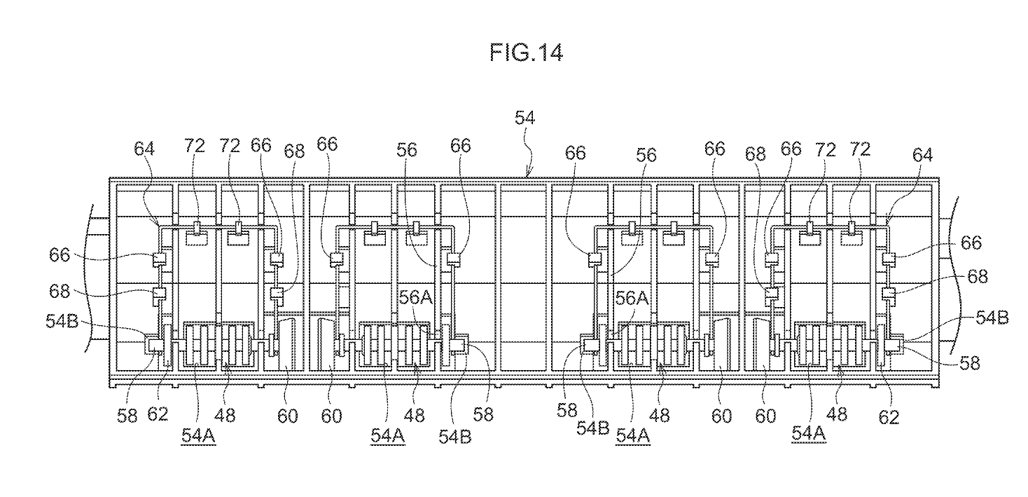

As shown in FIGS. 13 and 14, each pinch roller set 48 is formed to include one large-diameter circular plate (roller) (an example of a large-diameter portion) 60, and plural (for example, six) small-diameter circular plates (roller) (an example of small-diameter portions) 62. Plural (for example, four) of pinch roller sets 48 are provided at predetermined intervals therebetween in the sheet widthwise direction (in the axial direction of the discharge roller 46).

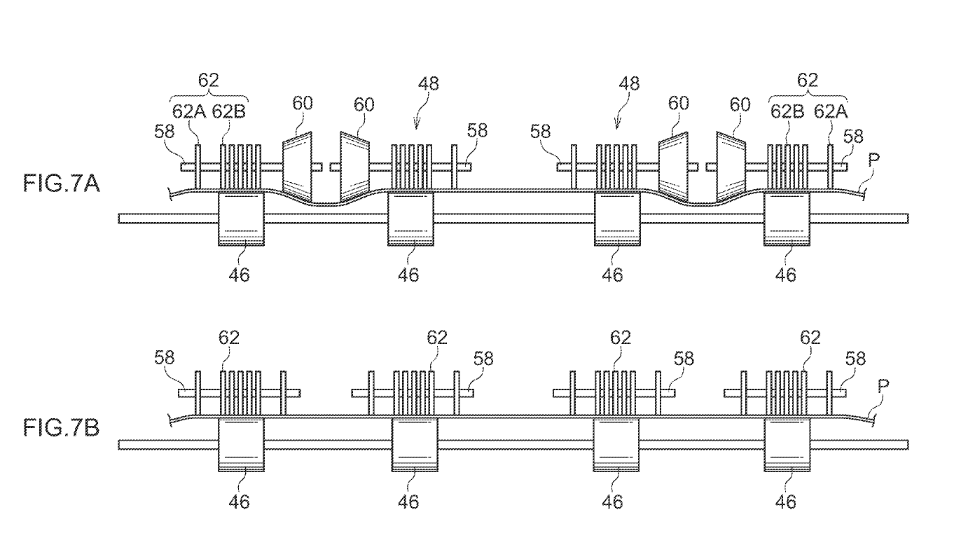

As shown in FIG. 7A, the large-diameter circular plate 60 and a small-diameter circular plate 62A which is disposed farthest away from the large-diameter circular plate 60 among other small-diameter circular plates 62 come in contact with the transported recording sheet P without coming in contact with (without facing) a roller part provided in the rotating shaft of the discharge roller 46. Five small-diameter circular plates 62B not including the small-diameter circular plate 62A that is disposed farthest away from the large-diameter circular plate 60 among the small-diameter circular plates 62 come in contact with (face) the roller part of the discharge roller 46 so as to transport the recording sheet P.

As a result, the large-diameter circular plate 60 and the small-diameter circular plate 62A at the end portion, both of which does not come in contact with (face) the roller part of the discharge roller 46, distorts the transported recording sheet P in undulated (waveform) manner (distorts the recording sheet in direction crossing the discharge direction of the recording sheet P in undulated form (waveform)), thereby adding stiffness to the discharged recording sheet P. Due to the aforementioned structure, failure of accommodating the recording sheet P, which is caused by the leading end of the recording sheet P in the discharge direction being caught by the paper discharge unit 18, is prevented.

The pinch roller sets 48 illustrated in FIG. 7A are provided such that two pinch roller sets are provided at right side and the other two pinch roller sets are provided at left side so as to be symmetrical to each other, and in each of the two pinch roller sets provided at the right side and the other two pinch roller sets provided at left side, the respective large-diameter circular plates 60 are disposed adjacent to each other. Each large-diameter circular plate 60 is formed in the shape of a truncated cone, and the large-diameter circular plates 60 of each of the two pinch roller sets provided at the right side and the other two pinch roller sets provided at left side are disposed such that the respective facing surfaces of the large-diameter circular plates 60 are large-diameter portion thereof. As a result, a large undulated shape (waveform) is formed in the recording sheet P.

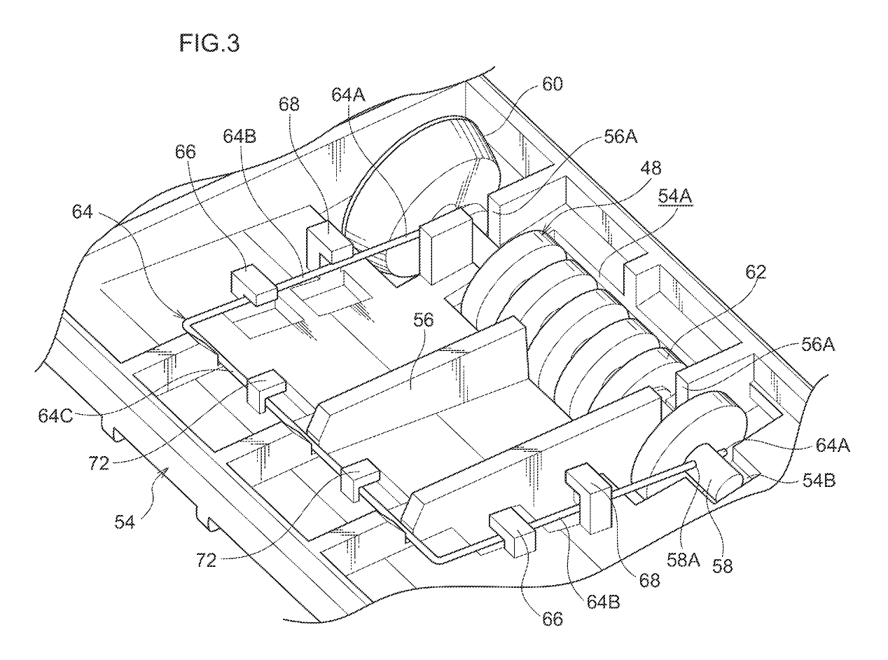

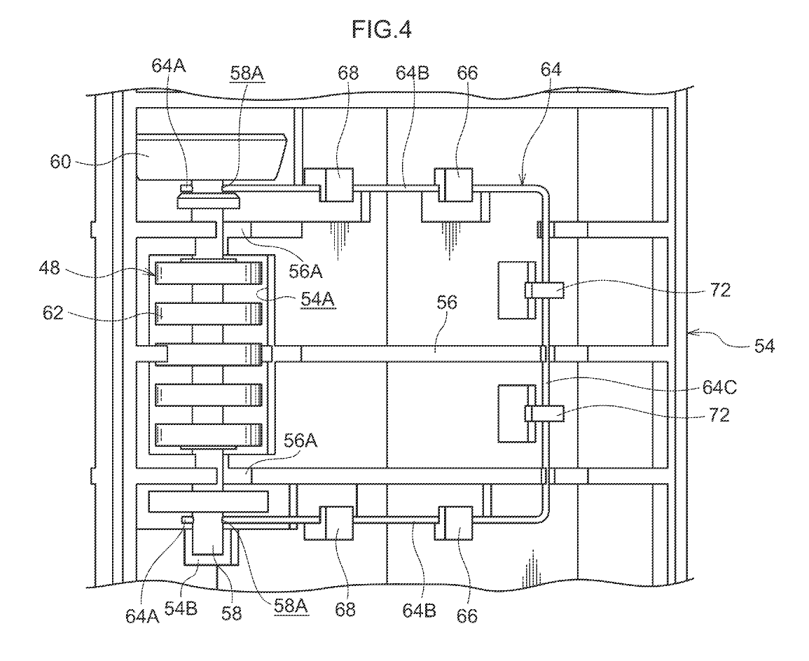

Further, as shown in FIG. 3 and FIG. 4, in each of the pinch roller sets 48, when the peripheral surfaces of rollers of the pinch roller set 48 are made to come in contact with the peripheral surface of the discharge roller 46 (when these rollers are disposed to face the discharge roller 46), the rotating shafts 58 of the respective pinch roller sets 48 are each held down (pressed) by a wire spring (which is a wire-like pressure applying member using deflection of a wire member and is an example of an urging member) 64 so as not to be separated from (so as not to come out from) the notch portions 56A.

In other words, the wire spring 64 is formed so as to have a U-shaped configuration when seen from the top, and bifurcated end portions 64A oriented to the downstream side in the sheet transporting direction are fixed by the end portions 64A being fitted and inserted into locking holes 58A, one of which holes is formed in a portion of the rotating shaft 58 between the large-diameter circular plate 60 and the small-diameter circular plate 62 and the other of which holes is formed in a portion of the rotating shaft 58 provided further at the outer side of the outermost small-diameter circulate plate 62, respectively.

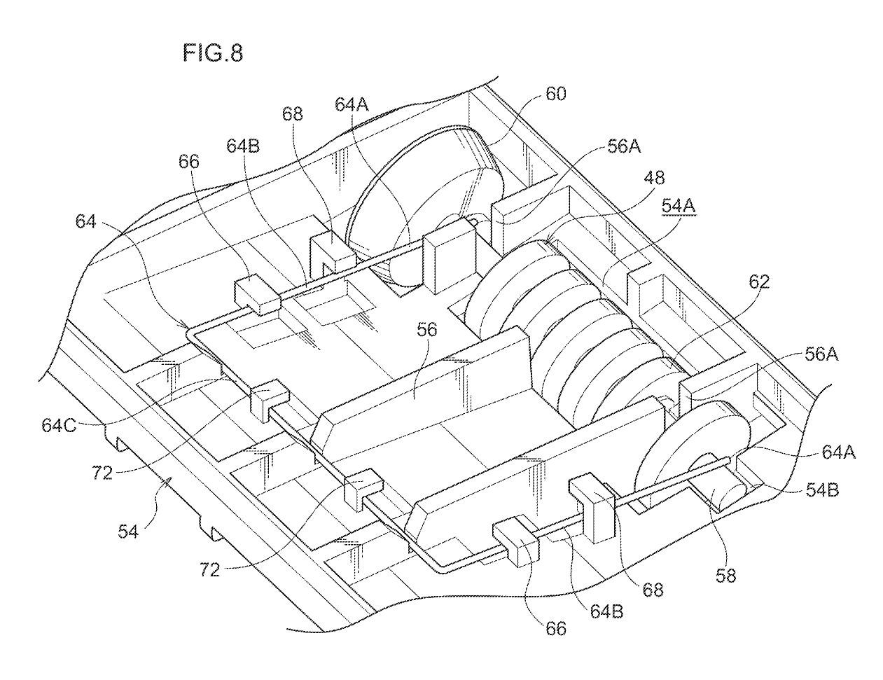

The method of fixing the leading end portions 64A on the rotating shaft 58 is not limited to the illustrated method, and any arbitrary methods can be used. Further, in a case of the pinch roller sets 48 formed by the large-diameter circular plate 60 and the small-diameter circular plates 62 being formed in an integral manner, it is possible that the leading end portions 64A are not fixed to the rotating shaft 58, but as shown in FIG. 8 through FIG. 10 the rotating shaft 58 may be held (pressed) down by using the elastic force of the wire spring 64 such that the leading end portions 64A are placed at the upper portions of the rotating shaft 58.

Further, a base portion 64C of the wire spring 64 which is at the upper stream in the sheet transporting direction of the wire spring 64 is latched by plural (for example, two) latching claws 72 provided protruding manner in the cover body 54, having substantially an inverted L-shaped configuration when seen from the side. A pair of leg portions (an example of part of urging member) extending from the base portion 64C of the wire spring 64 to the end portions 62A are also held (pressed) down by a pair of first holding members (an example of restricting member), respectively, provided protruding manner so as to face each other, having substantially an inversed L-shaped configuration when seen from the side.

As a result, when the peripheral surface of each roller of the pinch roller set 48 comes in contact with the peripheral surface of the discharge roller 46, the rotating shaft 58 of each roller of pinch roller set 48 is held down by the wire spring 64 so as not to come out from the notch portions 56A. That is to say, due to the aforementioned structure, the pinch roller set 48 is urged by the urging force (elastic force) of the wire spring 64 toward the discharge roller 46 and is made to abut by pressure against the peripheral surface of the discharge roller 46 with a predetermined pressure.

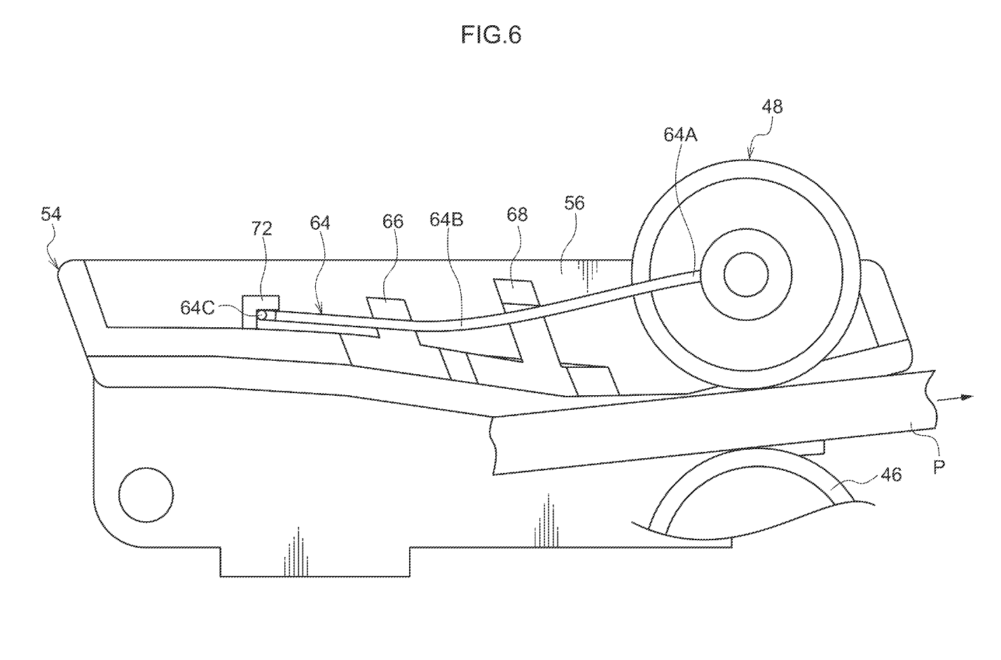

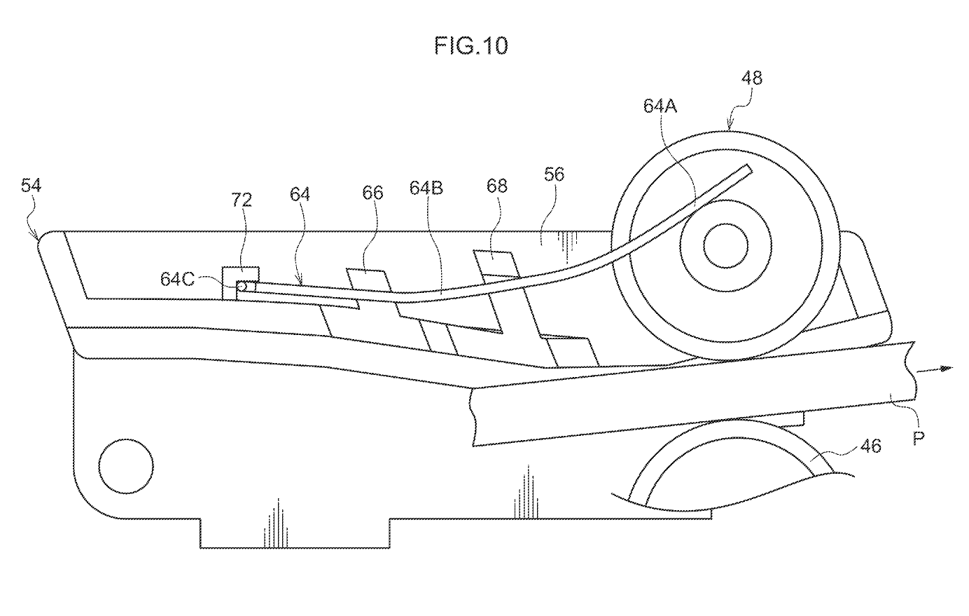

Further, at the cover body 54, a pair of second holding members (an example of restricting member) 68 are provided in protruding manner further at the downstream side in the sheet transporting direction than the pair of first holding members 66 so as to face each other, and heights of the pair of second holding members 68 are higher than that of the first holding members 66 and each have a substantially inverted L-shaped configuration when seen from the side. The second holding member 68 is, as shown in FIG. 6 and FIG. 10, holds another position on each of the leg portions 64B of the wire spring 64 when the thickness of the recording sheet P becomes larger (when the recording sheet is a cardboard sheet), so as to change the position or height of a supporting point (fulcrum) with respect to the point of action (the pinch roller set 48) on which the urging force of the wire spring acts (applies).

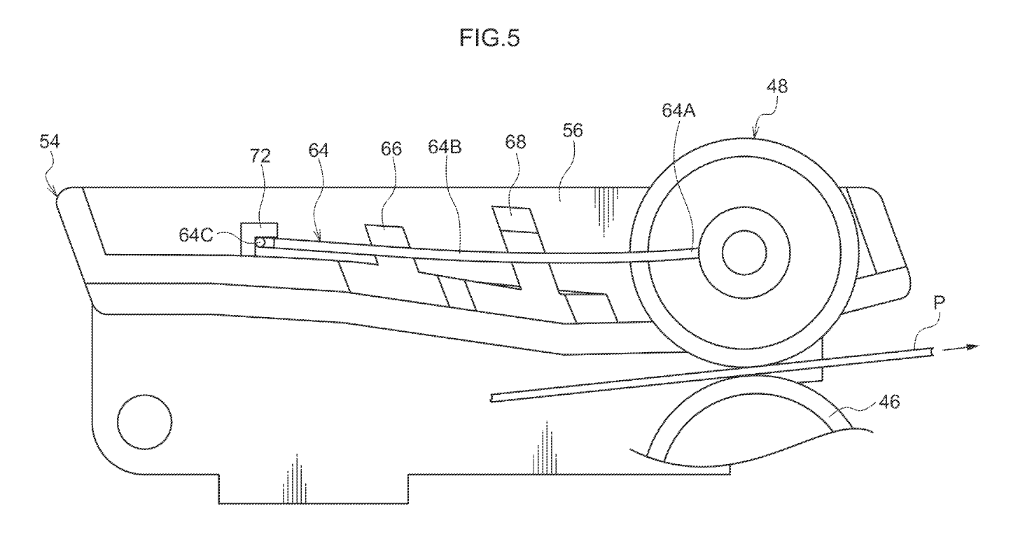

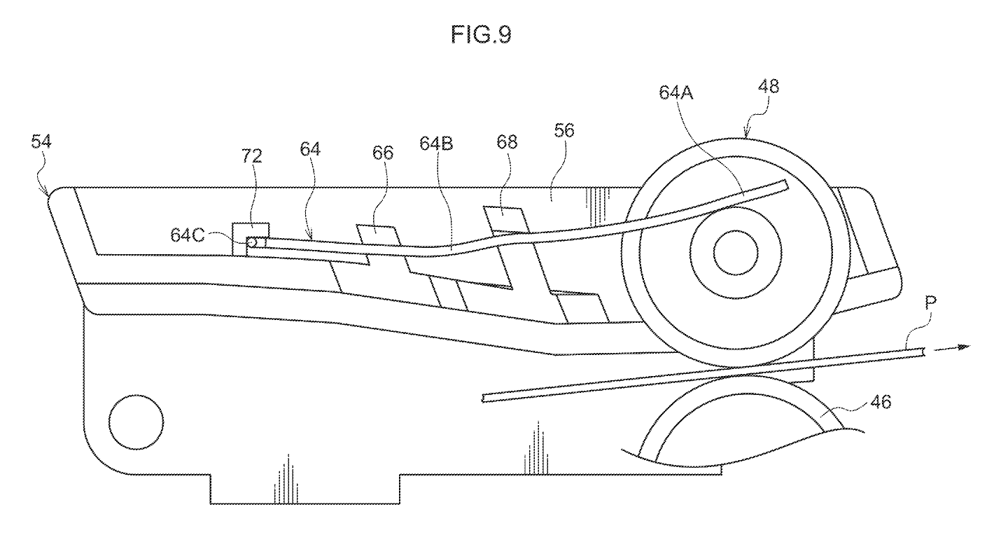

In other words, when the first holding member 66 holds the leg portion 64B of the wire spring 66, the pinch roller set 48 is urged toward the discharge roller 46 with the first holding member 66 serving as the supporting point. As shown in FIG. 5 and FIG. 9, when the recording sheet P such as plain paper is nipped and transported by the pinch roller set 48 and the discharge roller 46, the pinch roller set 48 is moved away from the discharge roller 46 by the recording sheet P. At this time, the leg portion 64B (the leading end portion 64A) deflects (elastic-deforms) upward with the first holding member 66 serving as the supporting point, and consequently, the pinch roller set 48 is made to generate downward urging force (toward the discharge roller 46).

On the other hand, as shown in FIG. 6 and FIG. 10, when the recording sheet P such as a cardboard sheet is nipped and transported by the pinch roller set 48 and the discharge roller 46, the pinch roller set 48 is moved away from the discharge roller 46 by the recording sheet P more largely than the case of using plain paper. At this time, the leg portion 64B (the leading end portion 64A) deflects (elastic-deforms) upward with the second holding member 68 serving as the supporting point, whereby downward urging force (toward the discharge roller 46), which force is larger than that at the time of using the plain paper) is generated in the pinch roller set 48. That is, even if the thickness of the recording sheet P is changed, the load (urging force toward the discharge roller 46) corresponding to the thickness of the recording sheet P is automatically applied to the pinch roller set 48.

Next, the operations of the image forming apparatus 10 and the pinch roller 46 having the aforementioned structures are described. First, the recording sheet P placed at the uppermost position of the sheet cassette 16 is taken out by the feed roller 22, and is handled by cooperation of the feed roller 22 and the retard roller 24, and delivered to the transport path 20. Then, the recording sheet P delivered to the transport path 20 is sequentially transported by the registration roller 26 to the photoreceptor 30.

The surface (peripheral surface) of the photoreceptor 30 is in advance charged uniformly by the charging roller 32. Then, light is emitted from the light writing device 38 and the surface of the photoreceptor 30 is scanned, and a latent image based on image data is formed on the surface of the photoreceptor 30. Subsequently, the latent image is developed with a toner by the development device 34, and a toner image (a visible image) is formed on the surface of the photoreceptor 30.

When the recording sheet P is nipped and transported by the photoreceptor 30 and the backup roller 28, the toner image is transferred to the surface of the recording sheet P, and the recording sheet P onto which an unfixed toner image is transferred is transported to the fixing device 40. After the toner image is transferred to the recording sheet P, the surface of the photoreceptor 30 is subjected to cleaning processing by the cleaning device 36, and thereafter, the photoreceptor 30 gets ready for subsequent image forming processing.

The transferred unfixed toner image is fixed on the recording sheet P which is fed to the fixing device 40 in such a manner that the recording sheet P is nipped and transported by the heat roller 42 and the press roller 44. The recording sheet P on which the toner image is fixed is nipped and transported by the discharge roller 46 and the pinch roller sets 48, and is discharged onto the paper discharge unit 18.

Here, in a case in which the recording sheet P is plain paper, as shown in FIG. 5 and FIG. 9, the leg portion 64B of the wire spring 64 is held down (pressed) by the first holding member 66 from the upper side, whereby an allowable amount of which the pinch roller set 48 is moved away from the discharge roller 46 is restricted. By the leg portion 64B deflecting (elastic-deforming) upward with the first holding member 66 serving as the supporting point, the urging force acting toward the discharge roller 46 is generated at the pinch roller set 48.

On the other hand, in a case in which the recording sheet P is a cardboard sheet, as shown in FIG. 6 and FIG. 10, the leg portion 64B of the wire spring 64 is held down (pressed) by the second holding member 68 from the upper side, whereby an allowable amount of which the pinch roller set 48 is moved away from the discharge roller 46 is restricted. By the leg portion 64B deflecting (elastic-deforming) upward with the second holding member 68 serving as the supporting point, the urging force acting toward the discharge roller 46 is generated at the pinch roller set 48. Accordingly, the load (urging force) at the pinch roller set 48 varies depending on the type of the recording paper P, that is, depending on the time in which plain paper is used or a cardboard sheet is used.

That is, the distance between the pinch roller set 48 (the point of action) and the second holding member 68 (the supporting point) is shorter than the distance between the pinch roller set 48 (the point of action) and the first holding member 66 (the supporting point), and therefore, the load to be applied to the pinch roller set 48 when the recording paper P is a cardboard sheet is larger than that when the recording paper is plain paper. Accordingly, not only when the recording sheet P is plain paper, but also when it is a cardboard sheet, curling of the recording sheet P is straightened.

That is to say, the recording sheet P passing through the fixing device 40 is curled up at the heat roller 42 side, and therefore, in a case in which processing for the recording sheet to have undulated (waveform) shape is not carried out as shown in FIG. 7B, the recording sheet is discharged in the state of being curled up toward the paper discharge unit 18 side (indicated by an imaginary line (two-dot line) in FIG. 1). If a sufficient undulated (waveform) configuration is formed in the recording sheet P, curling that is toward the paper discharge unit 18 is alleviated.

Here, in a case in which the recording sheet P is plain paper, stiffness of the recording sheet is smaller than the case in which the recording sheet is a cardboard sheet. Therefore, even in a case in which only the first holding member 66 is provided, the elastic force (urging force) of the wire spring 64 allows the undulated (waveform) shape to be formed in the recording sheet P.

However, in a case in which the recording sheet P is a cardboard sheet, the stiffness of the recording sheet is large. Therefore, if the wire spring 64 yields to the stiffness of the recording sheet (that is, if the stiffness of the recording sheet wins the wire spring 64), the undulated (waveform) configuration cannot sufficiently be formed in the recording sheet P, so, the leading end of the recording sheet P in the discharging direction is caught by the paper discharge unit 18. Accordingly, the recording sheet P is discharged in an improper direction, which leads to occurrence of failure of accommodating of the recording sheet.

In a case in which the recording sheet P is a cardboard sheet, it may be considered that a firm or thick wire spring is used so that the wire spring 64 does not yield to the stiffness of the recording sheet. However, in this case, excessive nipping force of the discharge roller 46 and the pinch roller set 48 comes to be applied to the plain paper.

In the present exemplary embodiment, the second holding member 68 is provided in addition to the first holding member 66, and therefore, even when the recording sheet P is a cardboard sheet, the undulated (waveform) configuration can be sufficiently formed in the recording sheet P. Accordingly, there is no possibility that the leading end of the recording sheet P in the discharging direction is caught by the paper discharge unit 18 so the recording sheet P is discharged in an improper direction which leads to occurrence of failure of accommodating of the recording sheet.

That is, when the recording sheet P is thick, the large urging force is automatically applied, and therefore, the recording sheet P can be reliably held down (pressed). As a result, curling can be reduced. In such a way, in the present exemplary embodiment, even when not operated by a user, the load to be applied to the pinch roller set 48 is automatically adjusted depending upon the thickness of the recording sheet P (in accordance with the type of the recording sheet P), and therefore, curling of the recording sheet P is reduced irrespective of the thickness (type) of the recording paper P.

Further, with the structure in which the second holding member 68 is provided in addition to the first holding member 66, it is not necessary to make the wire spring 64 into a wire spring that is stronger or thicker more than required. Further, as compared to the case in which the second holding member 68 in not provided but the strong or thick wire spring is used, there is no possibility that the plain paper could be nipped by the discharge roller 46 and the pinch roller set 48 by the excess force.

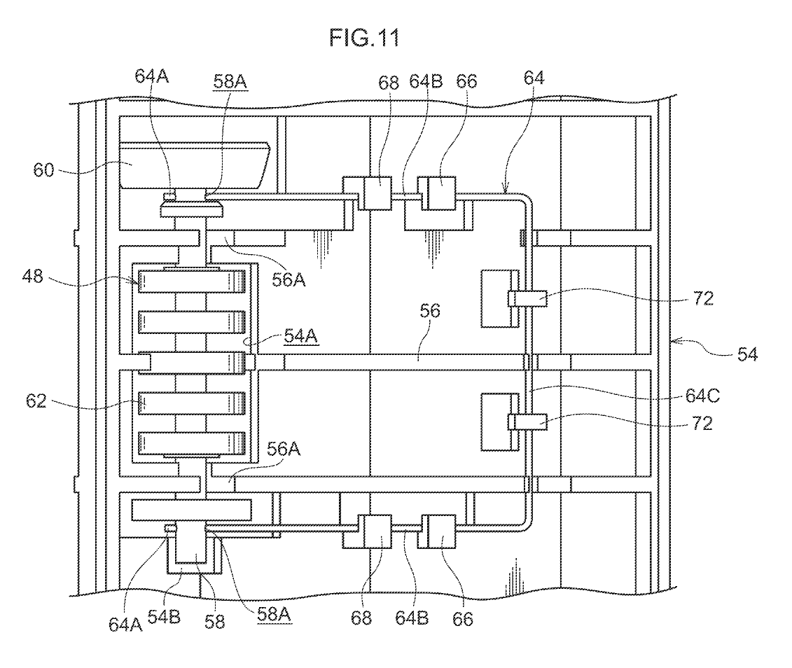

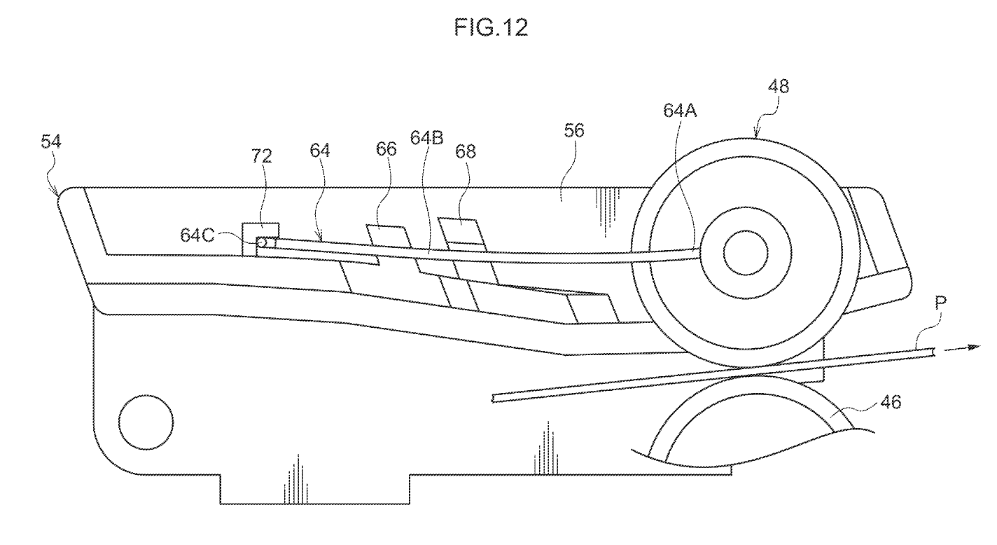

Further, as shown in FIG. 11, it is possible that the position of the second holding member 68 in the sheet transporting direction is appropriately varied depending on the thickness (type) of the recording sheet P to be transported. Moreover, as shown in FIG. 12, it is possible that the heightwise dimension of the second holding member 68 is appropriately varied depending on the thickness (type) of the recording sheet P to be transported. In this manner, by changing at least one of the position and the height of the second holding member 68, the load to be applied to the pinch roller set 48 can be appropriately varied.

Furthermore, it is possible that a region of the recording sheet P at which curling is reduced (straightened) in a concentrated manner is appropriately selected in any region along the sheet widthwise direction. That is to say, only pinch roller set(s) 48 at a desired portion(s) (position(s)) among plural sets of pinch roller sets 48 provided along the sheet widthwise direction (along the axial direction of the discharge rollers 46) are configured (selected) so as to be variable of the allowable amount of which the pinch roller are moved away from the discharge roller 46 along the sheet widthwise direction, so that curling at the desired portion(s) (position(s)) of the recording sheet P can be reduced in a concentrated manner.

That is, for example, as shown in FIG. 13, it is possible that the pinch roller sets 48 for which the second holding members 68 are provided in protruding manner so that urging force is varied depending on the thickness (type) of the recording sheet P are provided only at the central side in the sheet widthwise direction (in the axial direction of the discharge roller 46), thereby making is possible to reduce (straighten) curling occurring in the recording sheet P at the central portion thereof in the widthwise direction. Alternatively, for example, as shown in FIG. 14, it is possible that the pinch roller sets 48 for which the second holding members 68 are provided in protruding manner so that urging force is varied depending on the thickness (type) of the recording sheet P are provided only at both end portions in the sheet widthwise direction (in the axial direction of the discharge rollers 46), so that curling occurring in the recording sheet P at both end portions in the widthwise direction is reduced (straightened) in a concentrated manner.

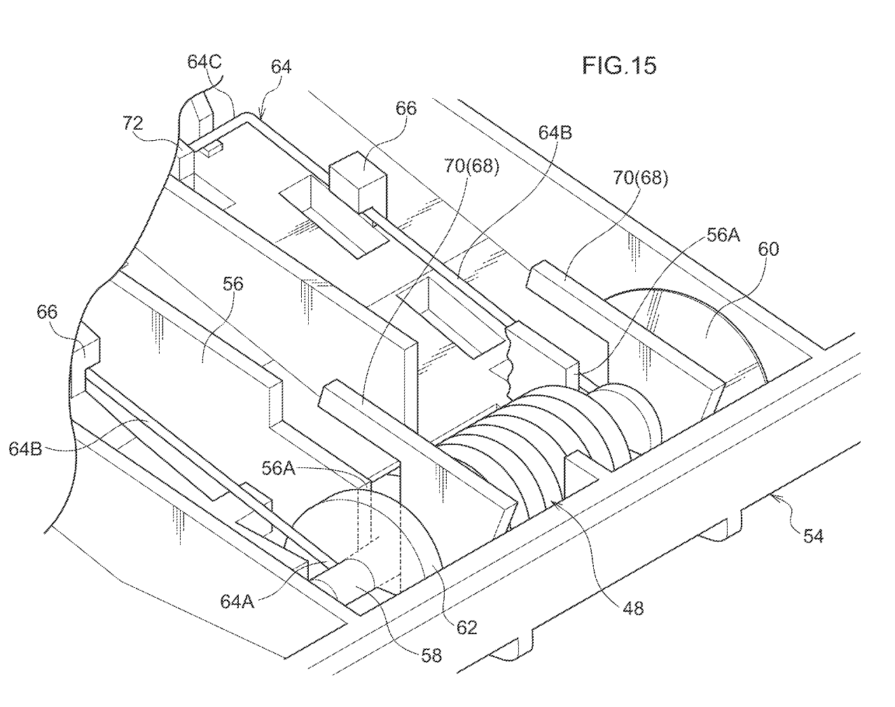

Next, a second exemplary embodiment of the present invention is described. Note that the same parts as those of the first exemplary embodiment are designated by the same reference numbers, and a description thereof (also including operation) is omitted. As shown in FIG. 15, the second exemplary embodiment is different from the first exemplary embodiment in that the second holding members 68 serving as an example of the restricting portion are replaced by substantially rectangular overhanging members 70 that overhang so as to be allowed to come in contact with the rotating shaft 58 of the pinch roller set 48.

That is, the overhanging member 70 is formed such that a portion of the reinforcing rib 56 extends to the upstream direction in the sheet transporting direction so as to overhang above the notch portion 56A formed in the reinforcing rib 56. When the recording sheet P such as a cardboard sheet is transported, the rotating shaft 58 interferes with (abuts) the overhanging member 70, whereby an allowable amount of which the pinch roller set 48 are moved away from the discharge roller 46 is restricted.

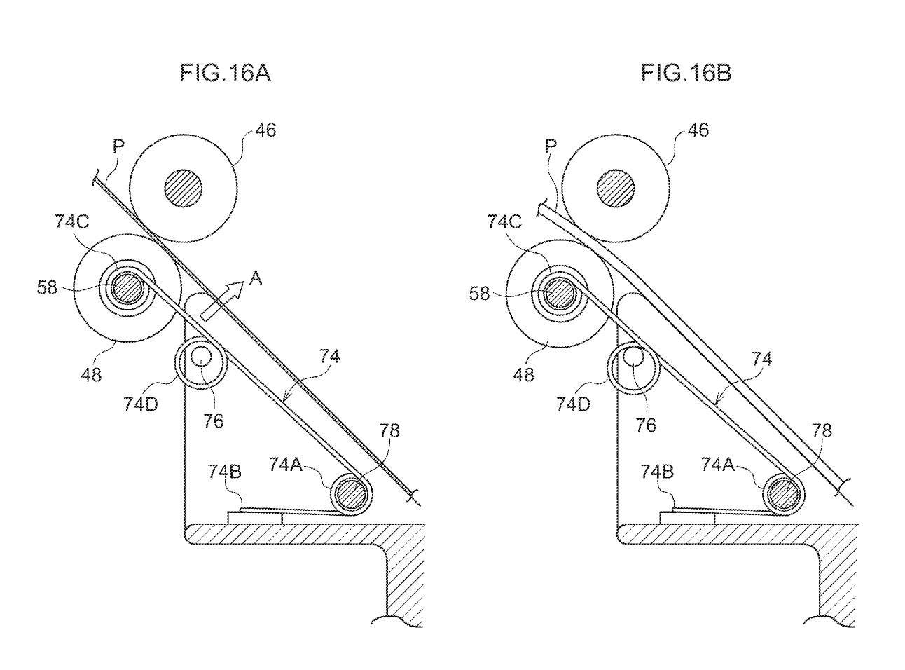

Finally, a third exemplary embodiment of the present invention is described. Note that the same parts as those of the first exemplary embodiment are denoted by the same reference numbers, and a description (also including operation) thereof is omitted. As shown in FIGS. 16A and 16B, in the third exemplary embodiment, the discharge rollers 46 are disposed at the upper side and the pinch roller sets 48 are disposed at the lower side, which is converse to the first exemplary embodiment.

The pinch roller set 48 is urged by a wire spring (an example of urging member) 74 toward the discharge roller 46. That is to say, a coil portion 74A of the wire spring 74 is engaged with a supporting shaft 78 projecting from a housing body 80 of the fixing device 40, and one end portion 74B of the wire spring 74 is latched on the housing body 80 at its proper position, whereby the other end portion 74C of the wire spring 74 urges in the direction indicated by arrow A in FIG. 16A.

Further, the other end portion 74C of the wire spring 74 is attached on the rotating shaft 58 of the pinch roller set 48. A winding portion 74D formed by at least one-winding is formed between the coil portion 74A and the other end portion 74C of the wire spring 74. A cylinder-shaped latching projection (an example of the restricting portion) 76 that projects from the housing body 80 is inserted into the winding portion 74D.

Accordingly, in the third exemplary embodiment, first, in a case where the recording sheet P is plain paper, as shown in FIG. 16A, the pinch roller set 48 is urged toward the discharge roller 46 by means of the urging force of the wire spring 74, and the recording sheet P is nipped and transported by the discharge roller 46 and the pinch roller set 48, whereby curling of the recording sheet P is reduced (straightened). At this case, the supporting point with respect to the point of action (the pinch roller set 48) at which the urging force of the wire spring 74 acts is the supporting shaft 78. That is, at this case, the latching projection 76 does not abuts (contacts) the winding portion 74D.

To the contrary, in a case where the recording sheet P is a cardboard sheet, as shown in FIG. 16B, when the recording sheet P is nipped and transported by the discharge roller 46 and the pinch roller set 48, the winding portion 74D of the wire spring 74 interferes with (abuts) the locking projection 76. Therefore, an allowable amount of which the pinch roller set 48 is moved away from the discharge roller 46 is restricted by the locking projection 76. That is to say, the supporting point with respect to the point of action (the pinch roller set 48) at which the urging force of the wire spring 74 acts is the locking projection 76.

Accordingly, when the recording sheet P is a cardboard sheet, the supporting point of the wire spring 74 for generating the urging force moves further toward the pinch roller set 48 side than the case in which the recording sheet P is plain paper, accordingly, the urging force increases. As a result, even in a case where the recording sheet P is a cardboard sheet, curling of the recording sheet P is reduced (straightened). As long as the wire spring 74 is structured so as to reliably interfere with the locking projection 76, the winding portion 74D may not need to be formed.

The recording medium transport mechanism of the present exemplary embodiments is described as above, but it is not limited to the illustrated examples. For example, a member that fixes the base portion 64C of the wire spring 64 is not limited to the locking claws 72, and any arbitrary member may be used for fixing. Further, the pinch roller set 48 may have any appropriate structure, and the present invention is not limited to the illustrated shapes, quantities and the like of the large-diameter circulate plates 60 and the small-diameter circulate plates 62.

Further, the recording medium transport mechanism according to the present exemplary embodiment may be provided anywhere in the image forming apparatus. More effectively, the recording medium transport mechanism may be provided at the downstream side of the fixing device 40, that is, in a region from the fixing device 40 to the discharge roller 46 and the pinch roller set 48, or in the reversal unit 50, and alternatively, it may be used in a post-processing device (not shown in the drawings), an relay-sheet transporting device for transporting the recording sheet P to the post-processing device, or the like.

What is claimed is:

1. A recording medium transport mechanism comprising:
a transporting device that is provided in a transport path of a recording medium, and that transports the recording medium by a drive roller and a facing roller that is disposed to face the drive roller;
an urging member that urges the facing roller toward the drive roller; and
a restricting portion that allows movement of the facing roller away from the drive roller against urging force of the urging member when the recording medium having thickness smaller than a predetermined thickness is transported in a region in which the drive roller and the facing roller face each other, and restricts an allowable amount of movement of the facing roller away from the drive roller when the recording medium having thickness equal to or larger than the predetermined thickness is transported in the region in which the drive roller and the facing roller face each other compared to an allowable amount of movement of the facing roller away from the drive roller when the recording medium having thickness smaller than the predetermined thickness is transported.

2. The recording medium transport mechanism of claim 1, wherein the restricting portion restricts the allowable amount by changing at least one of position or height of a supporting point with respect to a point of action at which the urging member applies the urging force on the facing roller.

3. The recording medium transport mechanism of claim 2, wherein the urging member is a wire spring, and the supporting point is configured by a holding member that holds a part of the wire spring.

4. The recording medium transport mechanism of claim 1, wherein
the restricting portion is configured by an overhanging member that overhangs so as to be able to come in contact with a rotating shaft of the facing roller, and
when the facing roller moves away from the drive roller against the urging force of the urging member, the rotating shaft is interfered with by the overhanging member, whereby the allowable amount is restricted.

5. The recording medium transport mechanism of claim 1, wherein
the drive roller includes a rotating shaft and a roller portion provided on the rotating shaft; and
the facing roller includes a small-diameter portion that comes in contact with the roller portion, and a large-diameter portion that is disposed coaxially with the small-diameter portion and does not come in contact with the roller portion.

6. A fixing device comprising:
a fixing unit in which a recording medium onto which an unfixed image is transferred is nipped and transported and the unfixed image is fixed on the recording medium;
a transporting device that is provided at a downstream side of the fixing unit in a direction in which the recording medium is transported, and that transports the recording medium by a drive roller and a facing roller that is disposed to face the drive roller;
an urging member that urges the facing roller toward the drive roller; and
a restricting portion that allows movement of the facing roller away from the drive roller against urging force of the urging member when the recording medium having thickness smaller than a predetermined thickness is transported in a region in which the drive roller and the facing roller face each other, and restricts an allowable amount of movement of the facing roller away from the drive roller when the recording medium having thickness equal to or larger than the predetermined thickness is transported in the region in which the drive roller and the facing roller face each other compared to an allowable amount of movement of the facing roller away from the drive roller when the recording medium having thickness smaller than the predetermined thickness is transported.

7. The fixing device of claim 6, wherein the restricting portion restricts the allowable amount by changing at least one of position or height of a supporting point with respect to a point of action at which the urging member applies the urging force on the facing roller.

8. The fixing device of claim 7, wherein the urging member is a wire spring, and the supporting point is configured by a holding member that holds a part of the wire spring.

9. The fixing device of claim 6, wherein
the restricting portion is configured by an overhanging member that overhangs so as to be able to come in contact with a rotating shaft of the facing roller, and
when the facing roller moves away from the drive roller against the urging force of the urging member, the rotating shaft is interfered with by the overhanging member, whereby the allowable amount is restricted.

10. The fixing device of claim 6, wherein
the drive roller includes a rotating shaft and a roller portion provided on the rotating shaft; and
the facing roller includes a small-diameter portion that comes in contact with the roller portion, and a large-diameter portion that is disposed coaxially with the small-diameter portion and does not come in contact with the roller portion.

11. The fixing device of claim 6, wherein a plurality of sets of the drive roller, the facing roller and the urging member are provided along the axial direction of the drive roller, and
the restricting portion is provided in one or more selected sets among the plurality of sets.

12. The fixing device of claim 11, wherein the restricting portion is provided only in the set located at the central side in the axial direction of the drive roller.

13. The fixing device of claim 11, wherein the restricting portion is provided only in the sets located at both end sides in the axial direction of the drive roller.

14. An image forming apparatus comprising:
an accommodating unit in which a recording medium is accommodated;
a transfer unit in which an unfixed image is transferred onto the recording medium that is fed from the accommodating unit;
the fixing device including:
a fixing unit in which a recording medium onto which an unfixed image is transferred is nipped and transported and the unfixed image is fixed on the recording medium;
a transporting device that is provided at a downstream side of the fixing unit in a direction in which the recording medium is transported, and that transports the recording medium by a drive roller and a facing roller that is disposed to face the drive roller;
an urging member that urges the facing roller toward the drive roller; and
a restricting portion that allows movement of the facing roller away from the drive roller against urging force of the urging member when the recording medium having thickness smaller than a predetermined thickness is transported in a region in which the drive roller and the facing roller face each other, and restricts an allowable amount of movement of the facing roller away from the drive roller when the recording medium having thickness equal to or larger than the predetermined thickness is transported in the region in which the drive roller and the facing roller face each other compared to an allowable amount of movement of the facing roller away from the drive roller when the recording medium having thickness smaller than the predetermined thickness is transported,
that fixes the unfixed image transferred by the transfer unit; and
a discharge unit to which the recording medium on which the image is fixed by the fixing device is discharged.

15. The recording medium transport mechanism of claim 1, wherein by a portion of the urging member being latched at the restricting portion when the recording medium having thickness equal to or larger than the predetermined thickness is transported, urging force of the urging member when the recording medium having thickness equal to or larger than the predetermined thickness is transported is made larger than urging force of the urging member when the recording medium having thickness smaller than the predetermined thickness is transported.
